(19) United States
(12) Patent Application Publication
(10) Pub. No.: US 2007/0030211 A1
(43) Pub. Date: Feb. 8, 2007

(54) WEARABLE MARINE HEADS-UP DISPLAY SYSTEM

(75) Inventors: Jonathan A. McGlone, Seattle, WA (US); Dereck B. Clark, Glendale, AZ (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 11/421,391

(22) Filed: May 31, 2006

Related U.S. Application Data
(60) Provisional application No. 60/687,097, filed on Jun. 2, 2005.

(51) Int. Cl. G09G 5/00

(52) U.S. Cl. 345/7

(57) ABSTRACT

A data communication system for use on a surface or subsurface vessel. The system includes a base system and a plurality of user components. The base system includes a marine enhanced ground proximity warning system (MEGPWS), a communication component, and a wireless transceiver coupled to the MEGPWS. The user component includes a wireless transceiver, an earpiece speaker, a microphone, a heads-up display (HUD), and a processor coupled to the wireless transceiver, the earpiece speaker, the microphone, and the HUD. The processor generates an image for presentation on the HUD based on information received from the base system. Also, the processor receives voice signals from the microphone, prepares and transmits the received voice signals for transmission to the base system, receives voice signals from the base system via the wireless transceiver, and prepares and outputs the voice signals received from the base system via the earpiece speaker.

### PRIORITY CLAIM

The application claims the benefit of U.S. Provisional Application Ser. No. 60/687,097 filed Jun. 2, 2005, the contents of which are hereby incorporated by reference.

### BACKGROUND OF THE INVENTION

Masters, Mates, Pilots, and persons-in-charge of the safe navigation of vessels need current real-time information to ensure safe operation of their vessel. Typically there is a single (occasionally two) console that is available for all personnel to look at to obtain navigation information for situational awareness.

This information may be relayed verbally or by other individuals leaving their post to view the centrally located console. In close-quarter situations and/or times of reduced visibility, verbal communication may be misunderstood due to ambient noise, language barriers, distance, or other scenarios; or the time it takes to walk to the primary console can result in a distraction or a significant “heads-down” time period that can lead to a lack of situational awareness that could potentially jeopardize safe vessel operation.

Therefore, there is a need to present current real-time information regarding vessel course, speed, position, and relevant terrain caution/warning information to several people simultaneously in different locations on a vessel.

### SUMMARY OF THE INVENTION

The present invention provides a data communication system for use on a surface or subsurface vessel. The system includes a base system and a plurality of user components. The base system includes a marine enhanced ground proximity warning system, a communication component, and a wireless transceiver coupled to the marine enhanced ground proximity warning system. The user component includes a wireless transceiver, an earpiece speaker, a microphone, a heads-up display (HUD), and a processor coupled to the wireless transceiver, the earpiece speaker, the microphone, and the HUD. The processor includes a display component that generates a image for presentation on the HUD based on information received from the base system via the wireless transceivers and a communication component that receives voice signals from the microphone, prepares and transmits the received voice signals for transmission to the base system, receives voice signals from the base system via the wireless transceiver, and prepares and outputs the voice signals received from the base system via the earpiece speaker.

In one aspect of the invention, the base system further includes a global positioning system sensor, an automatic identification system, a depth sounder, an inertial reference system, and an electronic chart display information system, all of which are in data communication with the marine enhanced ground proximity warning system.

### BRIEF DESCRIPTION OF THE DRAWINGS

The preferred and alternative embodiments of the present invention are described in detail below with reference to the following drawings:

FIGS. 1 and 2 illustrate schematic diagrams of the wearable heads-up display system formed in accordance with embodiments of the present invention; and

FIGS. 3 and 4 illustrate screenshots of images presented over a head-up display device included within the system shown in FIGS. 1 and 2.

### DETAILED DESCRIPTION OF THE PREFERRED EMBODIMENT

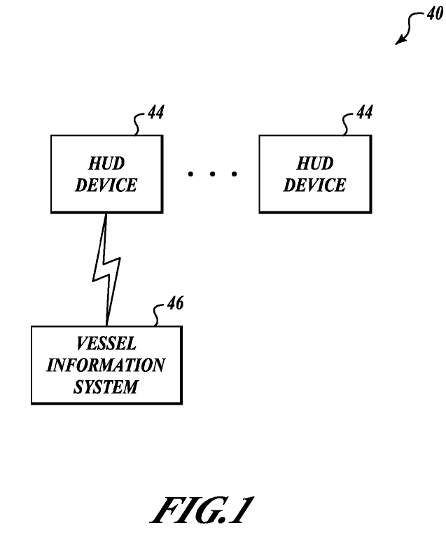

The system integrates three major components; the Marine Enhanced Ground Proximity Warning Computer (MEGPWS); a wireless communication link (Bluetooth/Ethernet); and a wearable Heads-Up Display. The system overview diagram is shown in FIG. 1.

FIG. 1 illustrates a block diagram of an example wearable heads-up display (HUD) system 40 formed in accordance with embodiment of the present invention. The system 40 includes one or more HUD devices 44 that are in wireless data communication with a vessel information system 46. The HUD devices 44 are worn by operators of the vessel in which the system 40 is included. The vessel information system 46 includes any information associated with the vessel including, but not limited to, position, course, speed, vessel dimensions, time, weather information, or other nautical information, and obstacles such as sea surface, shore, or man-made objects.

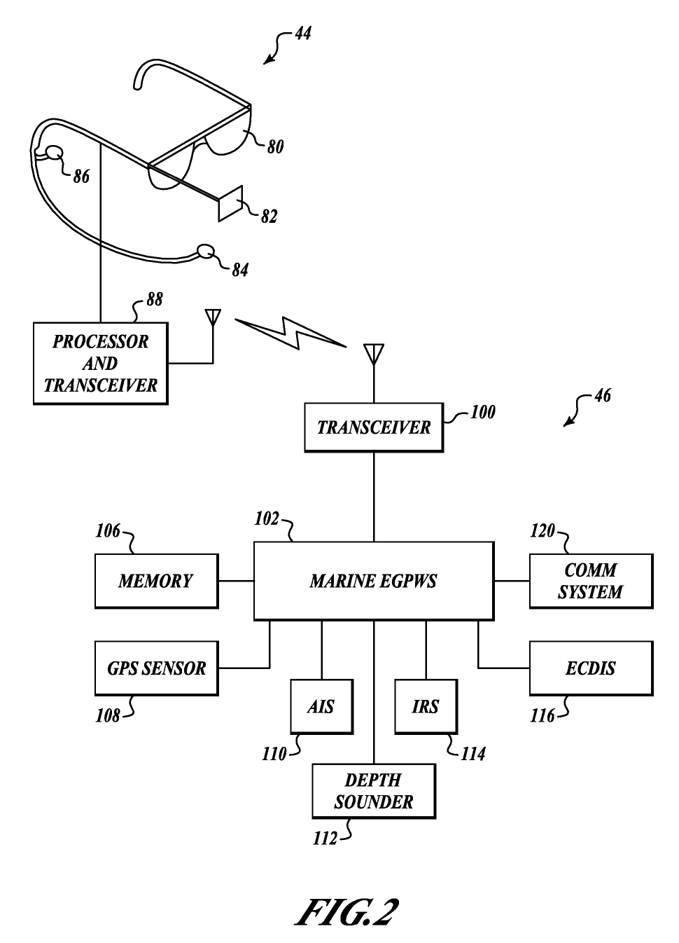

FIG. 2 illustrates a more detailed breakdown of the components shown in FIG. 1. In this example, each HUD device 44 includes a flip-up HUD 82, a microphone 84, an earpiece 86, and a wireless transceiver 88, all of which are attached to a device to be worn on the head, such as glasses 80. A signal and display processor are included within the wireless transceiver 88 or the flip-up HUD 82 for processing signals received by the transceiver 88 and converting the signals for display on the HUD 82. Also, the processor would be used for converting audio signals for output over the earpiece 86 or for receiving signals from the microphone 84 and converting them for wireless delivery over the wireless transceiver 88.

The vessel information system 46 includes a wireless transceiver 100 and a marine enhanced ground proximity warning system (MEGPWS) 102 that is in data communication with the wireless transceiver 100. The MEGPWS 102 is also in data communication with the plurality of other shipboard systems, such as a memory 106, a global positioning system (GPS) sensor 108, an automatic identification system (AIS) 110, a depth sounder 112, an inertial reference system (IRS) 114, an electronic chart display information system (ECDIS) 116, and a communication system 120. The memory 106 stores various marine, man-made, and natural obstructions.

Wireless communication between the transceivers 88 and 100 is performed using any of the number of wireless communication protocols, such as Bluetooth or 802.11. Wireless repeater devices may be positioned at strategic locations on a vessel in order to ensure that the HUD devices are able to communicate with the MEGPWS 102 anywhere on the vessel.

The MEGPWS 102 prepares information for transmission via the transceiver 100 to the HUD devices 44 based on the information that is received from the various components 106-120. The MEGPWS 102 utilizes a comprehensive terrain/bathymetric database with Terrain Alert Detection algorithms to provide position and situational awareness information, which is broadcast via an encrypted wireless transmission to all the HUD devices 44. Some MEGPWS functionality that is communicated to the to the HUD devices 44 is described in U.S. Pat. Nos. 6,750,815, 6,469,664, and 6,734,808, all of which are hereby incorporated by reference.

The MEGPWS 102 receives data from the components 106-120 and retransmits the data if the MEGPWS 102 is configured to accept and broadcast such data. For example, voice communications can be communicated between the HUD devices 44 via the MEGPWS 102 and the communication system 120. Also, the communication system 120 may send communications directly to the HUD devices 44 via the transceiver 100 or another transceiver (not shown). The HUD devices 44 include a mute button or communication button (not shown) for controlling voice communication operations. The communication system 120 may also link the HUD devices 44 sources external to the vessel (VHF communications).

The HUD 82 is hinged to allow the wearer to quickly flip the HUD 82 into view or into a stow position. The HUD devices 44 include mechanisms for controlling configurations of display screen option various views (e.g. primary Integrated Bridge System (IBS), external, cabin, engine room, etc.). The HUD devices 44 include a light intensity knob (not shown) for controlling light intensity of the content displayed on the HUD 82 and a volume control for controlling volume of sound outputted to the earpiece 86. The knob is located in a convenient location and is connected to the processor and transceiver 88.

The processor in the transceiver 88 includes a voice recognition component for acting on spoken commands received by the microphone 84. In another embodiment, the MEGPWS 102 includes a voice recognition component for processing voice commands sent from the HUD device 44.

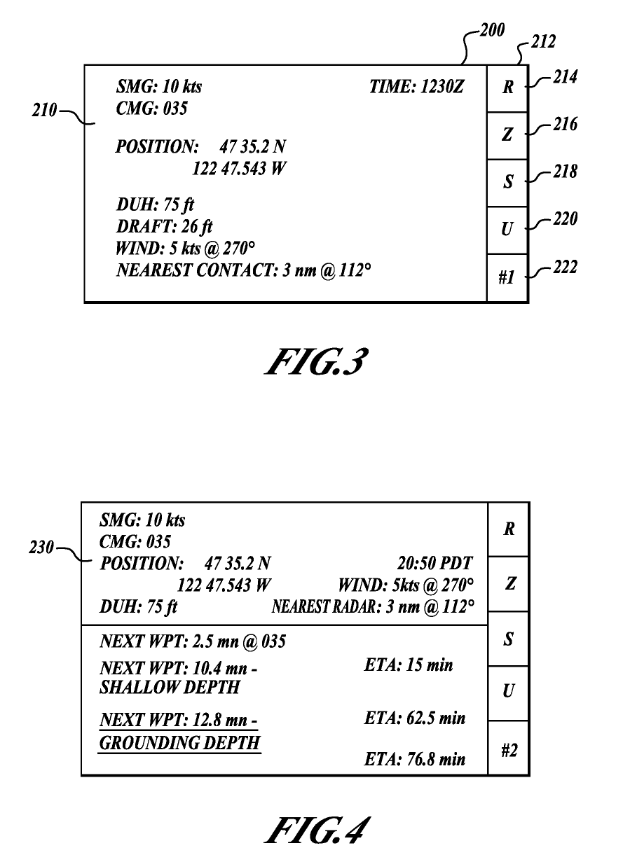

FIG. 3 illustrates a first screenshot 200 that is presented to a user on the HUD 82. The presented image includes a main data display area 210 and a menu column 212. The main display area 210 presents information such as Speed Made Good (SMG), Course Made Good (CMG), time, position, Depth Under Keel (DUK), vessel draft, wind speed and direction, and any contact information. Alerts (e.g., caution or warning) may also be posted in the main display area 210 if received from the MEGPWS 102. MEGPWS Information is displayed as text or symbol, colored text or symbol, or flashing text or symbol, depending on the normal, caution, or warning state.

The menu column 212 includes selectable menu items 214-220. Some of the selected bold menu items, when selected, change the information or content displayed into the display area 210. The menu column 212 includes a red light item 214, a zoom item 216, a split screen item 218, and a U-item 220. The HUD devices 44 can be configured to display selected information as deemed appropriate by the Master or Person-In-Charge (PIC). Each transceiver 88 has the ability to pull up a configuration menu to select the items available. The MEGPWS 102 controls the signals available to the transceiver 88 that are allowed for each installation. The U-item 220 when selected presents a User-Configuration menu. The knob located on or near the transceiver 88 allows a user to scroll through menu options by rotating the knob. When the knob is pushed in, a selection is made of the menu option that is highlighted.

Also identified in the lower corner below the menu column 212 is a HUD device indicator 222. The HUD device indicator 222 indicates the number the present HUD. Selection of the red light item 214 puts the HUD 82 in a red light/night ops mode. Selection of the zoom item 216 zoom in part or all of the image displayed on the HUD 82.

FIG. 4 illustrates a display area 230 that is presented after user has selected the split screen menu item 218. In an upper half of the display area 230 is presented the information that was previously presented in display area 210, or a subset thereof. Displayed in a bottom half of the display area 230 includes course information related to the next three-way points and the estimated time of arrival at each of the waypoints.

The device 44 also includes a picture-in-picture (PIP) feature that provides for simultaneous display of information on the HUD 82. The HUD 82 may be controlled using voice commands that are processed by the voice recognition component described above. The voice recognition component is also used to convert voice commands for controlling other systems, such as radio operations.

While the preferred embodiment of the invention has been illustrated and described, as noted above, many changes can be made without departing from the spirit and scope of the invention. For example, this invention can be applied to surface and subsurface vessels. Accordingly, the scope of the invention is not limited by the disclosure of the preferred embodiment. Instead, the invention should be determined entirely by reference to the claims that follow.

1. A data communication system for use on a vessel, the system comprising:
a base system comprising:
a marine enhanced ground proximity warning system;
a communication component coupled to the marine enhanced ground proximity warning system; and
a wireless transceiver coupled to the marine enhanced ground proximity warning system; and
a plurality of user components, each of the user components comprising:
a wireless transceiver;
an earpiece speaker;
a microphone;
a heads-up display (HUD); and
a processor coupled to the wireless transceiver, the earpiece speaker, the microphone, and the HUD, the processor comprising:
a display component for generating a image for presentation on the HUD based on information received from the base system via the wireless transceivers; and
a communication component for receiving voice signals from the microphone, preparing and transmitting the received voice signals for transmission to the base system, receiving voice signals from the base system via the wireless transceiver, and preparing and outputting the voice signals received from the base system via the earpiece speaker.

2. The system of claim 1, wherein the base system further comprises:
a global positioning system sensor;
an automatic identification system;
a depth sounder;
an initial reference system; and
an electronic chart display information system, all of which are in data communication with the marine enhanced ground proximity warning system.

3. The system of claim 1, wherein the HUD is hinged for occupying an active and a stowed position.

4. The system of claim 1, wherein the transceivers communicate via a wireless protocol.

5. The system of claim 4, wherein the wireless protocol is 802.11.

6. The system of claim 1, wherein the processor receives warning information generated by the marine enhanced ground proximity warning system and the display component generates at least one of an image or an alert signal, wherein the generated image is presented on the HUD and the alert signal is outputted through the earpiece speaker.

7. The system of claim 1, wherein the user components include a night operations mode.

8. The system of claim 1, wherein the communication component of the base system allows a user of one user component to communicate with a user of another user component via wireless transmission with the base system.

9. The system of claim 1, wherein the display component performs zooming of an image.

10. The system of claim 1, wherein the display component includes a split screen component for presenting a split screen on the HUD with data from a first source being presented in a first portion and data from a second source being presented in a second portion.

11. The system of claim 1, wherein the display component presents navigation information that is generated by the marine enhanced ground proximity warning system.
